(19) United States
(12) Patent Application Publication
(10) Pub. No.: US 2019/0007819 A1
(43) Pub. Date: Jan. 3, 2019

(54) SYSTEM, APPARATUS, AND METHOD FOR PROVIDING EMERGENCY SUPPORT SERVICES

(71) Applicant: OPOSSUM LTD., London (GB)

(72) Inventors: Luca MARCHIOL, Udine (IT); Stefano PARLAMENTO, Tavagnacco (IT); Matteo PUPPIS, Basiliano (IT)

(21) Appl. No.: 15/745,281

(22) PCT Filed: Jul. 16, 2015
(86) PCT No.: PCT/EP2015/066322

§ 371 Date: Jan. 16, 2018

(51) Int. Cl. H04W 4/90; H04W 4/029; H04W 4/44

(52) U.S. Cl. CPC H04W 4/90; H04W 4/44; H04W 4/029

(57) ABSTRACT

An emergency support system includes a first communication device used by the user and a second communication device of an emergency service provider. The first communication device is configured to automatically detect a triggering event corresponding to the emergency and to transmit its current geographical location along with images/video of its surroundings to the second communication device. The second communication device is configured to automatically or manually analyze the received information transmitted by the first communication device to determine at least one suitable tutorial for displaying at the first communication device. The second communication device is further configured to automatically activate other camera devices or surveillance cameras in proximity to the first communication device for capturing additional details corresponding to the reported emergency to determine severity or reliability of the reported emergency. Furthermore, the emergency support system allocates in the best manner the resources in case of an emergency.

### FIELD OF THE INVENTION

Embodiments of the present invention in general, concern a system, apparatus, and method to provide emergency support services to a user of a communication device. More particularly, embodiments of the present invention concerns to a system, apparatus, and method of automatically apprising an emergency call center corresponding to an emergency condition via a network.

### BACKGROUND OF THE INVENTION

Nowadays, wireless communication devices (e.g., tablets, cell phones, Smart phones, PDAs, or other types of portable communication devices) are omnipresent. Further, the wireless communication devices have been used to store emergency information, also known as ICE (In Case of Emergency) information. More specifically, an ICE application in a wireless communication device enables its owner to store information in case of an emergency situation (e.g. medical history like allergies, current medications, emergency contact persons, emergency service providers etc.). Such information can be used by the owner itself or by any third person trying to help the owner in case of an emergency.

Moreover, it is substantive to provide such information correctly to emergency service providers in event of an emergency. However, sometimes during an emergency, victims do not have time or ability to stay connected and clearly convey their circumstances or location to an emergency service provider. Furthermore, in an emergency, victims generally do not have enough time for sustaining a call with the emergency service providers to explicate the emergency. Therefore, emergency service providers oftentimes remain deprived of any additional information required for assisting the victims during emergencies.

For example, in a scenario of a fire accident, emergency service providers generally need to know a number of details corresponding to the situation including precise location (building number, floor number, room number, etc.) of the accident area. However, victims are mostly hastened by the situation and provide very limited information. Also, there is no way to determine if the provided emergency information is existent or misleading.

Additionally, in case of certain medical emergencies such as ‘high degree burns’, it is crucial for the emergency support providers to teach the victim (or victim's caretaker) certain viable ways of providing first aid. However, in such emergency situations victims are generally panic-stricken and therefore have receded abilities to correctly understand instructions provided by the emergency service providers. Ultimately, the emergency service providers get averted from efficiently providing medical help to the victims on time and the victims gets deprived off the medical attention they deserve.

Therefore, there is a need for a system and method that is capable of drawing necessary information corresponding to an emergency, independent from the information provided by the victims or spectators of the emergency.

The applicant has devised, tested and embodied the present invention to overcome the shortcomings of the state of the art and to obtain these and other purposes and advantages.

### SUMMARY OF THE INVENTION

Embodiments in accordance with the present invention disclose a wireless communication device for providing real-time emergency support to a user in response to a triggering event corresponding to an emergency. The triggering event may include an event of dialing a communication call to the at least one emergency contact. The emergency may include at least one of medical emergency, epidemics, criminal activity, illegal activity, fire emergency and natural disaster. In an embodiment, the wireless communication device is a portable device. In another embodiment, the wireless communication device is installed in a vehicle. Further, the wireless communication device comprises a processor operatively coupled to a memory for storing user information and at least one emergency contact. In an embodiment, the emergency contact comprises contact information of at least one of known personnel of the user and of an emergency service provider. The wireless communication device further comprises a location-determining subsystem for determining a current geographical location of the wireless communication device in response to the triggering event. In an embodiment, the location-determining subsystem determines the location of the wireless communication device via at least one of Global Positioning System, Wi-Fi positioning system, and tower triangulation system.

The wireless communication device further comprises a recording subsystem operatively coupled to the processor and memory for recording at least one of image, audio and video in response to the triggering event. In an embodiment, the recording subsystem comprises at least one of a microphone and an image sensor. The wireless communication device further comprises a communication interface coupled to the processor and memory for transmitting the current geographical location and at least one of recorded image, recorded audio, recorded video and the user information to the at least one emergency contact in response to the triggering event, wherein the transmitted information is to apprise the emergency contact corresponding to an emergency. In an embodiment, the communication interface connects the wireless communication device to Internet and also helps in receiving instructions or data from the emergency contact. The wireless communication device further configured to transmit a request to other devices in proximity for capturing data comprising at least one of image, audio and video corresponding to the emergency.

Embodiments in accordance with the present invention discloses a computer-implemented method for providing real-time emergency support to a user of a wireless communication device in response to a triggering event, wherein the wireless communication device comprises a memory having stored therein user information and at least one emergency contact. The method further comprises the steps of determining a current geographical location of the wireless communication device in response to the triggering event, recording at least one of image, audio and video in response to the triggering event, and transmitting the current geographical location and at least one of recorded image, recorded audio, recorded video and the user information to the at least one emergency contact in response to the triggering event, wherein the transmitted information is to apprise the emergency contact corresponding to an emergency.

Embodiments in accordance with the present invention disclose a system for providing real-time support to a user in case of an emergency in response to a triggering event corresponding to the emergency. The system includes a first communication device used by the user, the first communication device comprising a first non-transitory memory operatively associated with at least one first processor, wherein the first non-transitory memory comprises user information and at least one emergency contact. The first communication device is configured to determine its current geographic location in response to the triggering event, record at least one of image, video and audio in response to the triggering event, and transmit the current geographic location and at least one of recorded image, recorded video, recorded audio and the user information to the at least one emergency contact in response to the triggering event.

Further, the user information may include, but is not restricted to, personal information of user, business information of user, and medical history/information of the user. In an embodiment, the first communication device may include user information of more than one user. Further, the emergency contacts may include contact details of one or more individuals or of service providers. For example, the emergency contacts may include contact information of at least one known personnel or relative or of any general emergency service provider. Moreover, the triggering event may include, but is not restricted to, detection of a call made to an emergency contact, detection of unusual vital signs of its user, detection of an instruction provided by its user to call for emergency, detection of sudden change in temperature or pressure, and like.

The system further includes a second communication device of the at least one emergency contact, the second communication device comprising a second non-transitory memory operatively associated with at least one second processor, wherein the second communication device comprises at least one tutorial and contact information of at least one service personnel. The second communication device is configured to receive and analyse the information transmitted by the first communication device, activate at least one camera device in the proximity of the first communication device to capture additional information corresponding to the emergency, provide received information and captured additional information of the first communication device to at least one service personnel, and transmit tutorial-data corresponding to the emergency to the user of the first communication device.

In an embodiment, the information received by the second communication device is analysed to determine at least one of the current geographical location and medical condition of the user. Further, the received information and the captured additional information of the first communication device is displayed to the at least one service personnel on the second communication device. In an embodiment, the at least one service personnel is determined based on the geographical location of the first communication device. Also, in an exemplary embodiment the first communication device and the second communication device are connected via Internet. Further, in an embodiment of the present invention, the second communication device is a device installed at an emergency service provider's location. In another embodiment, the second communication device is a device installed in an emergency service providing vehicle. Moreover, the at least one camera device for capturing the additional data may include at least one of surveillance camera and portable device camera.

Embodiments in accordance with the present invention disclose a system for providing real-time support to a user in response to a triggering event. The system comprises a wireless communication device that comprises a non-transitory memory operatively associated with at least one processor, wherein the non-transitory memory comprises user information and at least one emergency contact. The wireless communication device is configured to determine a current geographical location of the wireless communication device in response to the triggering event, record at least one of image, audio and video in response to the triggering event, transmit the current geographical location and at least one of recorded image, recorded audio, recorded video and the user information to the at least one emergency contact in response to the triggering event corresponding to an emergency, receive tutorial data corresponding to the emergency from the emergency contact, and display the received tutorial data corresponding to the emergency to the user.

Embodiments in accordance with the present invention disclose a communication device for providing real-time emergency support to a user of a remote device. The communication device comprises a processor operatively coupled to a memory for storing one or more tutorials corresponding to at least one type of emergency and contact information of at least one service personnel. The communication device further comprises a transceiver for receiving data from the remote device via a network corresponding to an emergency. The communication device is further configured to automatically transmit the received data to the at least one service personnel. The communication device is further configured to automatically analyse the received data to determine and transmit at least one tutorial from the one or more stored tutorials based on the emergency to the remote device over the network.

Embodiments in accordance with the present invention disclose a system for providing real-time support to a user in response to a triggering event. The system comprises a wireless communication device that comprises a non-transitory memory operatively associated with at least one processor, wherein the non-transitory memory comprises at least one emergency contact. The wireless communication device is configured to determine a current geographical location of the wireless communication device in response to the triggering event, record at least one of image, audio and video in response to the triggering event, transmit the current geographical location and at least one of recorded image, recorded audio, and recorded video to the at least one emergency contact in response to the triggering event corresponding to an emergency, and transmit a request to other devices in proximity for capturing data comprising at least one of image, audio and video corresponding to the emergency, wherein the other devices transmits the captured data directly to the at least one emergency contact or to the wireless communication device.

Embodiments in accordance with the present invention disclose a computer program product comprising a non-transitory computer readable storage medium having user information, at least one emergency contact, and computer usable program code for providing real-time emergency support to a user in response to a triggering event. The computer program product comprises computer program code configured to determine a current geographical location of a wireless communication device in response to the triggering event, computer program code configured to record at least one of image, audio and video in response to the triggering event, and computer program code configured to transmit the current geographical location and at least one of recorded image, recorded audio, recorded video and the user information to the at least one emergency contact in response to the triggering event, wherein the transmitted information is to apprise the emergency contact corresponding to an emergency. In an embodiment of the present invention, the computer program product further comprises computer program code for transmitting a request to other devices in proximity for capturing data comprising at least one of image, audio and video corresponding to the emergency.

The present invention can provide a number of advantages depending on its particular implementation. First, the present invention provides an emergency call support Smartphone application (e.g., ICE call) that allows first aid operators (who receive a help request) to obtain top level information about the emergency situation for saving people's life. For example, on a device equipped with the ICE call application, in case of call to a first assistance number, the camera of the device will activate to report in real time the situation to a display device installed in the operation headquarters. This allows the operator to clearly understand the danger entity, people collapsed or involved in an accident or in a robbery etc.

The ICE call application also allows to localize the caller by a GPS positioning system and according to the detected danger it can activate a video-tutorial on the calling device (e.g. in case of cardiac arrest can start a reanimation video-tutorial). The application can also activate the other camera devices near to the calling device to obtain a complete vision about the general situation. Further, the object of the ICE call application is to allow an active collaboration between the caller and the rescuing, in such a manner to displace proportional help to the emergency entity and to minimize the assistance time. Furthermore, a display device can also be installed on the means of transport used to reach the place interested by the emergency to obtain an active cooperation between help and caller.

Another advantage of the present invention includes capturing additional information corresponding to an emergency situation with help of camera devices owned by public or government. For example, certain wireless communication devices (e.g., cell phone devices that are pre-installed with ICE call application) which are available in the proximity of the emergency or hazard situation, a message asks owner of the wireless communication device if he/she wants to activate the ICE application for capturing details on the emergency situation. Only after the application has been activated, the camera device is able to record at least one of image, audio and video of the hazard situation.

For example, in beginning of any emergency call (e.g. 911) the ICE call application is automatically turned on. It can forward the caller GPS positioning and the video streaming from the integrated device camera to the local emergency operating center. Once the dispatcher has sent the appropriate emergency vehicle (e.g., police vehicles, fire trucks and/or ambulances) the rescue team can obtain target dynamic localization, scenario, and victims visualization before arrival through a portable tablet or other mobile devices on board that are installed with the ICE call application. Moreover, the process from the ‘call-for-help’ to the conclusion of the rescue operations is based on standardized response protocols (Dispatch Systems). Three cornerstones define this process that includes a precise localization of the event and of the potential victims, accurate assessment of the situation, and effective support to the caller while waiting for the rescue team. The idea is to optimize and to coordinate with any available resource for saving as much time as possible especially while assisting medical emergencies.

These and other aspects, characteristics and advantages of the present disclosure will be better understood with reference to the following description, drawings and attached claims. The drawings, which are integrated and form part of the present description, show some forms of embodiment of the present invention, and together with the description, are intended to describe the principles of the disclosure.

### BRIEF DESCRIPTION OF THE DRAWINGS

The above and still further features and advantages of the present invention will become apparent upon consideration of the following detailed description of embodiments thereof, especially when taken in conjunction with the accompanying drawings, and wherein:

FIG. 1 illustrates an exemplary environment in which various embodiments of the present invention are implemented;

FIG. 2 illustrates a block diagram of a wireless communication device, in accordance with an embodiment of the present invention;

FIG. 3 illustrates a block diagram of an emergency service providing communication device, in accordance with an embodiment of the present invention;

FIGS. 4-10 illustrates various block diagrams highlighting features of the present invention in various embodiments;

FIG. 11 illustrates a flow diagram for providing real-time emergency support to a user of a wireless communication device in response to a triggering event, in accordance with an exemplary embodiment of the present invention; and

FIG. 12 illustrates a flow diagram for using an automated computing device for providing real-time emergency support to a user of a remote device, in accordance with an exemplary embodiment of the present invention.

### DETAILED DESCRIPTION OF SOME FORMS OF EMBODIMENT

The description shall now refer in detail to the various forms of embodiment of the present invention, of which one or more examples are shown in the attached drawings. Each example is supplied by way of illustration of the invention and shall not be understood as a limitation thereof. For example, the characteristics shown or described insomuch as they are part of one form of embodiment can be adopted on, or in association with, other forms of embodiment to produce another form of embodiment. It is understood that the present invention shall include all such modifications and variants.

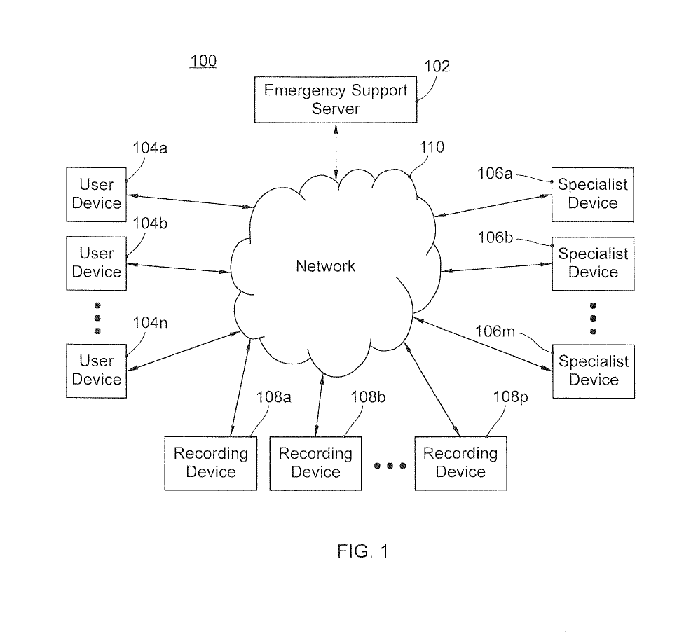

FIG. 1 illustrates an exemplary environment 100 where various embodiments of the present invention are implemented. The environment 100 includes an emergency support server 102 connected to a plurality of devices 104a-n, 106a-m, and 108a-p via a network 110, wherein the numbers n, m, and p are arbitrary numbers representing same or different number of devices. Hereinafter, the user devices 104a-n, may collectively be referred to as “user devices 104”, the specialist devices 106a-m may collectively be referred to as “specialist devices 106”, and the recording devices 108a-p may collectively be referred to as “recording devices 108”.

Further, the user devices 104 may refer to electronic devices that may be utilized by individuals to access and communicate with the emergency support server 102. In an embodiment of the present invention, the user devices 104 are portable wireless communication devices such as but not restricted to cell phones, tablets, laptops, etc. In an embodiment of the present invention, the user device 104 may be installed in a vehicle. It is being understood that the support server 102 may be integrated in the user device 104. Further, the specialist devices 106 may refer to electronic devices that may be utilized by emergency support providing specialists to communicate with the emergency support server 102 or with the user devices 104. Similarly, the recording devices 108 may refer to electronic devices that may be utilized by the emergency support server 102 to record audio, video, or images of their respective geographical area. In an embodiment of the present invention, the recording devices 108 may also be utilized by the specialist devices 106.

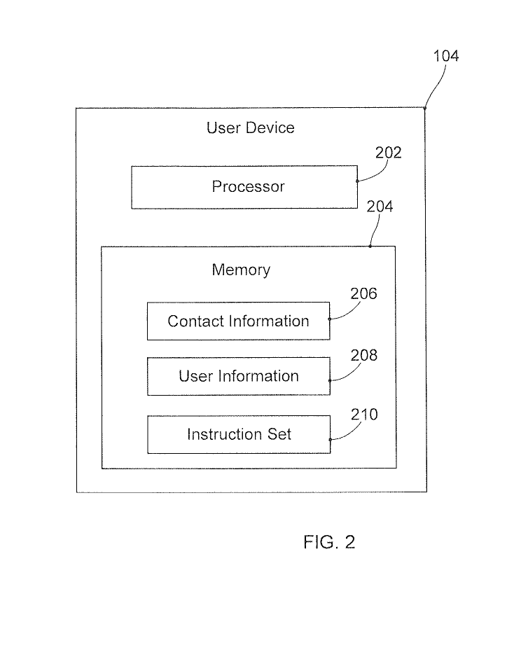

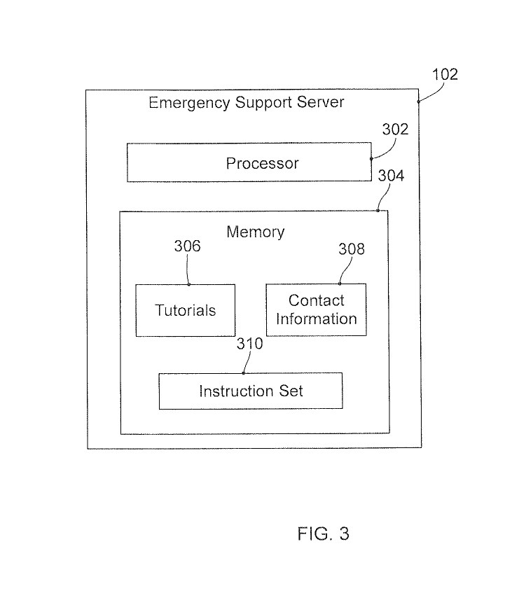

Examples of the user devices 104, specialist devices 106, and recording devices 108 may include, but are not restricted to, a desktop computer, a laptop, a mobile/cell phone, a smart phone, a personal digital assistant (PDA), a tablet computer, and the like. Further, the network 110 may include, but is not restricted to, a communication network such as Internet, PSTN, Local Area Network (LAN), Wide Area Network (WAN), Metropolitan Area Network (MAN), and so forth. In an exemplary embodiment of the present invention the recording devices 108 may further include dedicated surveillance cameras, surveillance cameras installed by government, personal CCTV cameras and personal camera devices of pre-registered individuals, and like. More details on the functioning of the devices 104, 106, and 108 are provided further in conjunction with FIG. 2 and FIG. 3 of the present invention.

In an exemplary embodiment of the present invention, the user devices 104 are installed with an automatic emergency detection and notification system (hereinafter, referred to as “notification system”). In an embodiment of the present invention, the notification system may be implemented as a software application (or combination of software and hardware), similar to an ‘ICE call’ software app. Further, the notification system installed in the user devices 104 is configured to automatically detect an emergency situation based on a triggering event and further to automatically apprise the emergency support server 102 corresponding to the detected emergency.

The triggering event may include, but is not restricted to, detection of a call made to an emergency contact, detection of unusual vital signs of its user, detection of an instruction provided by its user to call for emergency, detection of sudden change in temperature or pressure, and like. More details on the triggering events are provided further in conjunction with FIG. 2 and FIG. 3 of the present invention. In one embodiment of the invention, user device 104 may also be configured to detect the physiological parameters (such as blood pressure, consciousness, breathing, heart rate, etc.) of its user to generate the triggering event. In another embodiment of the invention, physiological parameters can be determined using a separate medical device which is in communication with the user device 104.

Additionally, the notification system is further configured to record current geographical location of the user device 104 along with at least one of audio, video, and image of the emergency situation (via camera and microphone of the user device 104). The recorded information are transmitted to the emergency support server 102 via the network 110 along with the apprisal or separate from the apprisal.

Another one of the automatic actions performed by the notification system includes, changing automatically the emergency contact on the base of the positioning of the caller. In fact, emergency contact (or more than one selected contacts) will change on the base of the state or the region of a state in which the user device 104 is located.

The recorded information may be vital for the emergency support server 102 as it provides precise and reliable information corresponding to the emergency, which ultimately assists emergency support service providers in embarking upon the apprised emergency with an ameliorated approach. Further, the recorded information may be imperative for emergency support providers in determining reliability of the apprised emergency. Also, the recorded information may help the emergency support providers in determining severity of the situation, which may prove to be crucial in seeking certain government or legal permissions. More details corresponding to the functioning of the user device 104 and the emergency support server 102 are provided further in conjunction with FIG. 2 and FIG. 3 respectively of the present invention.

In a first and foremost embodiment of the present invention, the notification system of the user devices 104 is configured to determine an emergency situation based on the triggering event and is further configured for automatically performing certain actions that may or may not be pre-defined. In an embodiment of the present invention, one of the automatic actions performed by the notification system includes selection of at least one emergency contact to apprise about the detected emergency. The selection method may be based on current geographical location of the user device 104 to find an emergency contact in near proximity. The selection method may also include an instruction received from its user. The selection method may also include detection of a call made by its user to an emergency contact. The selection method may also include type of emergency detected by the notification system.

Another one of the automatic actions performed by the notification system includes, contacting the selected emergency contact (or more than one selected contacts) via the network 110. In an embodiment, the network 110 also includes short range communication networks such as Wi-Fi, RFID, Bluetooth, NFC, Zigbee, and like. The notification system provides at least one of the user information stored in the user device 104 along with its current geographical location to the selected emergency contact (such as the emergency support server 102).

For example, the notification system may apprise the emergency support server 102 that “a person named ‘David Miller’ has called for emergency support at time 8:31 AM on 20^{th} Jan. 2015. Location of the person is as following, room number FH02, third floor, hotel ‘XYZ’, Street ABC, City, MNOP”. The details of room number, floor, and hotel name may be extracted from Wi-Fi service of the hotel. In an embodiment, the notification system may also send audio/video recording of the call made to the emergency contact by the user. Moreover, in addition to informing the emergency contact, the notification system may also be configured to automatically apprise hotel staff corresponding to the emergency situation, wherein emergency contact details of the hotel staff may be retrievable by the notification system from the Wi-Fi service provided by the hotel. According to other embodiments, even if the notification system is described with reference to an application in hotels, it is obvious that a similar application may be also implemented to provide emergency in other environments such as trains, airplanes, boats and the like.

In addition, the notification system may also start recording at least one of audio, video, or images of its surrounding from camera and microphone of the user device 104 and may further transmit the recorded information to the selected emergency contacts. In an embodiment, the notification system first apprise the selected emergency contact corresponding to the detected emergency (with or without current geographical location) and later on sends additional details including at least one of audio, video, and images with more precise geographical location. The recording of the audio, video, and images (including quantity, quality, duration, and like) may be based on battery of the user device 104, available network bandwidth, or on type of emergency. The notification system may also initiate or accept audio/video conference with the selected emergency contacts or may transmit the recording information intermittently.

Another one of the automatic actions performed by the notification system includes transmitting open request in its near proximity via the network 110 to other nearby user devices 104 (that are also implemented with the notification system or the ICE call software app) for either providing help and/or for requesting them to activate their cameras to record more details of the emergency situations. If the request is accepted then the data captured via the other nearby user devices 104 may either be directly forwarded by to the selected emergency contacts or may be first received and then forwarded by the user device itself. In an embodiment, the open request may also be accepted by the recording devices 108 in proximity, if available.

Further, in an exemplary embodiment of the present invention, the emergency support server 102 is installed with an automatic emergency support providing system (hereinafter, referred to as “support system”) for providing automatic assistance to users of the user devices 104 in case of reported emergencies. In an embodiment, the support system may be implemented with a software application (or combination of software and hardware) installed in the emergency support server 102. More particularly, the support system is configured to determine content, context, type, and severity of reported emergencies for automatically taking necessary actions. One of the necessary actions is to notify one or more selected (based on pre-defined algorithm) service personnel (specialists) on their communication devices (hereinafter, referred to as the specialist devices 106) corresponding to the reported emergency by providing them with all of available information. In an embodiment, the purpose of the notification is to dispatch the selected specialists at the current geographical location of the reported emergency for providing emergency services. Detailed functionalities of the support system are explained further in conjunction with FIG. 2 and FIG. 3 of the present invention.

Another necessary action that may be taken by the support system is to determine at least one tutorial (pre-stored in memory or selected from Internet) based on the reported emergency and to transmit the determined tutorial to the user devices 104 (emergency reporting devices) for providing best possible support in absence of any specialist. In an embodiment, the tutorials are transmitted to the user devices in real time. The tutorials may include, but are not restricted to audio, video, graphical, and text tutorials. In addition, the tutorials may be provided by specialists in real time over audio or video conference. More details on the tutorials are provided further in conjunction with FIG. 2 and FIG. 3 of the present invention.

Another necessary action that may be taken by the support system is to determine availability of the recording devices 108 in the proximity of the user devices 104. The determined recording devices 108 may then be instructed (via the network 110) to record and transmit at least one of audio, video, and images of their surroundings with their precise geographical location to the support system. The received information from the recording devices 108 may then further be analysed and forwarded to the selected specialist devices 106. More details on the use of the recording devices 108 and the support system are provided further in conjunction with FIG. 2 and FIG. 3 of the present invention.

Further, in an embodiment, the support system functioning in the emergency support server 102 may also be implemented on a desktop computer, laptop, tablet, cell phone, and like owned by the emergency service providers. In another embodiment, the support system may also be implemented on the user devices 104 to assist users even in absence of the network 110. In another embodiment, the support system may be implemented on the specialist devices 106 for facilitating direct communication of the specialist devices 106 with the user devices 104. In another embodiment, the support system may also be implemented on the recording devices 108 for enabling the recording devices 108 to directly assist emergencies in their respective geographical areas. Detailed description of the aforementioned embodiments is provided further in conjunction with the FIG. 3 of the present invention.

The specialist device 106 can also be used to have a mapping of the emergency resources, such as emergency service vehicles like fire brigade vehicle, ambulance, police vehicle, rescue vehicles and similar, to require the intervention of a proportionate amount of emergency resources, to save time using the nearest and available emergency resources to the request place.

FIG. 2 illustrates a block diagram of a wireless communication device (such as the user device 104 as explained earlier in conjunction with FIG. 1 of the present invention), in accordance with an embodiment of the present invention. As depicted from the figure, the user device 104 includes a processor 202 and a memory 204 for data storage. The memory 204 further stores therein contact information 206, user information 208, and an instruction set 210. The instruction set 210 stored in the memory 204 uses the processor 202 to perform actions, e.g., receiving, storing, processing, and transmitting data stored in the memory 204. Further, the user device 104 also includes a communication interface (not shown) for connecting the user device 104 to the network 110 (as explained earlier in conjunction with FIG. 1 of the present invention).

In an embodiment of the present invention, the memory 204 may either be a primary memory or a secondary memory. For example, but not restricted to, random access memory (RAM), cache memory, hard disk drive (HDD), solid state drive (SSD), compact disk (CD), portable memories, and like. Moreover, the processor 202 represents at least one processor and may comprise more than one processor also.

The contact information 206 stored in the memory 204 may include, but is not restricted to, at least one contact of the emergency support server 102, at least one contact of the specialist devices 106 (as explained earlier in conjunction with FIG. 1 of the present invention) and at least one contact of the recording devices 108 (as explained earlier in conjunction with FIG. 1 of the present invention). Further, the contact information may include any information that enables the user device 104 to communicate with other devices, such as but not restricted to the emergency support server 102, specialist device 106, or the recording device 108. Furthermore, examples of the contact information may include, but are not restricted to, a phone number, fax number, IP address, email address, MAC address, subscriber ID, and like.

The user information 208 stored in the memory 204 may include, but is not restricted to, at least personal information, business information, medical information or medical history, and like. The personal information may include details like name, age, weight, height, address, contact information, details of family members and their contact information, etc. Similarly, business information may include details like company name, designation, insurance details, social security number, etc. Further, the medical history/information may include details like allergy information, current medications, and all history records of medical diagnosis and prescriptions. The user information 208 may be used by the emergency support server to better serve the user in case of any emergency. For example, medicines may be prescribed, or relatives may be automatically informed of any emergency situation, and like.

Additionally, the user device 104 may further include a Global Positioning System (GPS) chip (not shown) for determining precise geographical location. Also, the user device 104 may further include a camera and microphone (not shown) for recording at least one of image, video, and audio. In addition, the user device 104 may further include a Wi-Fi chip (not shown) for retrieving precise location of the user device and for contacting devices in proximity Moreover, other short range communication interfaces may also be a part of the user device 104 for communicating with devices available in proximity. Examples of such short range communication interfaces may include but are not restricted to Bluetooth, NFC, RFID, infrared, Zigbee, and like.

It will be appreciated by a person skilled in the art that the aforementioned communication interfaces and location determining systems are useful in the present invention for enhancing the communication and geo-location services. However, in no manner, these systems and interfaces should be considered as necessary components of the present invention as the present invention is functional with and without these systems and components. For example, even a basic cell phone having only GSM capabilities can be used to determine its current geographical location via GSM tower triangulation method and can be used to apprise emergency contacts with its determined location. However, with the availability of a Smart phone having camera, microphone, Wi-Fi, GPS, and like, the emergency contacts may be apprised with greater and more precise details corresponding to the emergency.

Furthermore, the GPS may be implemented with at least one of audio, video, and images to improve even better the emergency localisation in complex and particular environment, such as mountains or caves and the like, or in particular situations, like earthquakes, seaquakes or terrorist attacks.

In a first and foremost embodiment of the present invention, the user device 104 is configured to provide real time emergency support to its user in case of an emergency. In an embodiment, the emergency may be any emergency including, but not restricted to, at least one of medical emergency, epidemics, criminal activity, illegal activity, fire emergency and natural disaster. The emergency can be detected based on any triggering event such as but not limited to, detection of dialing a communication call to the at least one emergency contact, detection of unusual vital signs of the user, detection of rapid change in temperature or pressure, detection of a signal from the user, and like. Further, the user device 104 includes a processor that is operatively coupled to its memory for storing certain user information along with certain emergency contacts.

The user information may include, but is not restricted to, personal information of user, business information of user, and medical history/information of the user. In an embodiment, the user device 104 may include user information of more than one user. Further, the emergency contacts may include contact details of one or more individuals or service providers. For example, the emergency contacts may include contact information of at least one known personnel or relative or of any general emergency service provider.

Further, the user device 104 includes at least one location-determining subsystem for determining current geographical location of the wireless communication device in response to the triggering event. The location-determining subsystem may use at least one of the cell phone network, Global positioning system, or Wi-Fi communication system for determining the location of the user device 104 via at least one of tower triangulation system, Global Positioning System, and Wi-Fi positioning system respectively, which are state of the art location determining methods and therefore do not need any further description.

The user device 104 also includes a recording subsystem which is operatively coupled to the processor and memory for recording at least one of image, audio and video. The recording subsystem may include at least one of a camera, image sensor, and microphone for recording the image, audio and video of the emergency. Additionally, the user device 104 includes a communication interface coupled to the processor and memory for transmitting the current geographical location and at least one of the recorded image, recorded audio, recorded video and the user information to the at least one emergency contact for apprising the emergency contact corresponding to the emergency. The communication interface may include any of network interface controller, network interface card, network adapter, or physical network interface for enabling the user device to connect with the Internet or the network 110 (as explained earlier in conjunction with FIG. 1 of the present invention).

Further, the instruction set 210 stored in the memory 204 may include instructions (or algorithms) for automatically detecting the triggering event. In an embodiment, the instruction set 210 may be installed in a portable wireless communication device by installing a software application (such as an ICE app) dedicated to serve the purposes as claimed in the present invention. Further, the instruction set 210 includes instructions for enabling the location-determining subsystem in determining the current geographical location of the wireless communication device in response to the triggering event. The instruction set 210 further includes instructions for enabling the recording subsystem to record at least one of image, audio and video in response to the triggering event. The instruction set 210 further includes instructions for enabling the communication interface in transmitting the current geographical location and at least one of recorded image, recorded audio, recorded video and the user information to the at least one emergency contact in response to the triggering event, wherein the transmitted information is to apprise the emergency contact corresponding to an emergency. The instruction set 210 may further include instructions for determining physiological parameters of the user.

Further, the information transmitted to the emergency contact may help the emergency contact to dispatch help providers (specialists) at the location of user device 104. In addition, the information may further help the emergency contact to determine a graphical, textual, audio, or video tutorial (or instructions) that may help the user of the user device 104 in handling the reported emergency. Therefore, the instruction set 210 may further include instructions for enabling the communication interface in receiving instructions from the emergency contact, wherein the instructions may include graphical, textual, audio, or video tutorials or conferences corresponding to the emergency.

In another embodiment of the present invention, the instruction set 210 may further include instructions for enabling the communication interface to transmit a request to other devices in proximity for capturing data comprising at least one of image, audio and video corresponding to the emergency. The request to other devices may be provided via the network 110. In an embodiment, the other devices are pre-installed with instructions (or a software app) for receiving and displaying requests from all those devices that are also pre-installed with similar instructions (or with the software app). The requests sent to the other devices may ask permission from users of the other devices to record images, audio, or video of the emergency situation. The data recorded by the other devices may either be sent directly to the emergency contacts or may be received by the user device 104 via the network 110 for transmitting to the emergency contacts. In an embodiment, the other devices may include user devices 104, specialist devices 106, and recording devices 108.

In another exemplary embodiment of the present invention, the instruction set 210 may include instructions for the user device 104 to provide real-time emergency support to its user in response a triggering event. The instruction set 210 may further include instructions for the user device 104 for determining its current geographical location in response to the triggering event, for recording at least one of image, audio and video in response to the triggering event, and for transmitting the current geographical location and at least one of recorded image, recorded audio, recorded video and the user information to the at least one emergency contact in response to the triggering event. In an embodiment, the instruction set 210 may include instructions for the user device 104 for transmitting a request to other devices in proximity for capturing data comprising at least one of image, audio and video corresponding to the emergency.

In another exemplary embodiment of the present invention, the instruction set 210 may include instructions for the user device 104 for providing real-time emergency support to its user in response to a triggering event. The instruction set 210 may further include a computer program code configured to determine its current geographical location in response to the triggering event. The instruction set 210 may further include a computer program code configured to record at least one of image, audio and video in response to the triggering event. The instruction set 210 may further include a computer program code configured to transmit the current geographical location and at least one of recorded image, recorded audio, recorded video and the user information to the at least one emergency contact in response to the triggering event, wherein the transmitted information is to apprise the emergency contact corresponding to an emergency. In an embodiment, the instruction set 210 may further include a computer program code for transmitting a request to other devices in proximity for capturing data comprising at least one of image, audio and video corresponding to the emergency.

FIG. 3 illustrates a block diagram of a communication device (such as the emergency support server 102 as explained earlier in conjunction with FIG. 1 of the present invention), in accordance with an embodiment of the present invention. As depicted from the figure, the emergency support server 102 includes a processor 302 and a memory 304 for data storage. The memory 304 further stores therein tutorials 306, contact information 308, and an instruction set 310. The instruction set 310 stored in the memory 304 uses the processor 302 to perform actions, e.g., receiving, storing, processing, and transmitting data stored in the memory 304. Further, the emergency support server 102 also includes a communication interface (not shown) for connecting the emergency support server 102 to the network 110 (as explained earlier in conjunction with FIG. 1 of the present invention).

In an embodiment of the present invention, the memory 304 may either be a primary memory or a secondary memory. For example, but not restricted to, random access memory (RAM), cache memory, hard disk drive (HDD), solid state drive (SSD), compact disk (CD), portable memories, and like. Moreover, the processor 302 represents at least one processor and may comprise more than one processor also.

The tutorials 306 stored in the memory 304 comprise information corresponding to remedy of various emergency situations (as explained earlier in conjunction with FIG. 1 and FIG. 2 of the present invention). The tutorial information may be stored in form of text, image, graphic, audio, video, and like. In an embodiment, the tutorials may also include recorded audio/video conferences of certain prior incidences, where a specialist managed an emergency situation via the audio/video conferences. In another embodiment, the tutorials may include information specially drafted for handling particular types of emergency situations. For example, different tutorials may be stored corresponding to cardiac arrest situation, bone fracture situation, skin burn situation, and like.

The contact information 308 stored in the memory 304 may include, but is not restricted to, at least one contact of the at least one specialist device 106 and recording device 108 (as explained earlier in conjunction with FIG. 1 of the present invention). In an embodiment of the present invention, the contact information 308 may also include contact details of the user devices 104. Further, the contact information may include any information that enables the emergency support server 102 to communicate with other devices, such as but not restricted to the user device 104, specialist device 106, or the recording device 108. Furthermore, examples of the contact information may include, but are not restricted to, a phone number, fax number, IP address, email address, MAC address, subscriber ID, and like.

It will be appreciated by a person skilled in the art that the aforementioned functionalities of the emergency support server 102 are not limited to a server only. The block diagram of the emergency support server 102 is described here only for the purpose of defining best mode of the present invention. However, in no manner, should the functionalities defined in FIG. 1 and FIG. 3 of the present invention (of the emergency support server 102), be restricted to a server only. The functionalities defined for the emergency support server 102 could be very much functional in any other electronic device such as the user devices 104, specialist devices 106, and the recording devices 108 (as defined earlier in conjunction with FIG. 1 of the present invention).

In an embodiment of the present invention where the functionalities of the emergency support server 102 are implemented on the user devices 104, the user devices 104 will get able to display emergency specific tutorials to their users even in absence of any network as the tutorials will be stored within the user devices 104. The instructions stored in the user devices 104 will automatically select relevant tutorials for display based on a pre-defined triggering event (as explained earlier in conjunction with FIG. 1 and FIG. 2 of the present invention). Further, in an embodiment, where the tutorials are not stored in the user devices 104 due to memory constraints, the instructions stored in the user devices 104 will automatically search for relevant tutorials over Internet.

In another embodiment of the present invention where the functionalities of the emergency support server 102 are implemented on the specialist devices 106, the specialist devices 106 will directly receive emergency apprisals from the user devices 104 along with additional information comprising current geographical location, user information, image, audio, and video corresponding to the emergency. In an embodiment, the specialist devices 106 may be installed in emergency service vehicles such as fire brigade vehicle, ambulance, police vehicle, rescue vehicles, and like. In another embodiment, the specialist device 106 may belong to any known personnel of user of the user device 104. The specialist device 106 may therefore either automatically send relevant tutorials to the user device 104 or the specialists may manually send the tutorials. The specialist device 106 may also automatically initiate an audio/video conference with the user of the user device 104.

In another embodiment of the present invention where the functionalities of the emergency support server 102 are implemented on the recording devices 108, the recording devices 108 will directly receive emergency apprisals from the user devices 104 along with additional information comprising current geographical location, user information, image, audio, and video corresponding to the emergency. In an embodiment, the recording devices 108 may be contacted by the user devices via short range communication protocols such as Wi-Fi to relieve the user devices from burden of determining emergency contacts in near proximity. In another embodiment, the recording devices 108 may be contacted by the user devices via Internet based on their current geographical locations.

In a first and foremost embodiment of the present invention, a communication device such as the emergency support server 102 is configured to provide real time emergency support to a user of a remote device in case of an emergency. In an embodiment, the emergency may be any emergency including, but not restricted to, at least one of medical emergency, epidemics, criminal activity, illegal activity, fire emergency and natural disaster. Further, in an embodiment, the emergency support server 102 comprises a processor operatively coupled to its memory for storing one or more tutorials corresponding to at least one type of emergency and contact information of at least one service personnel or specialist. The emergency support server 102 further comprises a transceiver for receiving data from the remote device via a network corresponding to the emergency.

After receiving the data from the remote device, the emergency support server 102 automatically transmits the received data to the at least one service personnel or specialist. Additionally, the emergency support server 102 automatically analyses the received data to determine and transmit at least one tutorial from the one or more stored tutorials based on the emergency to the remote device over the network. In an embodiment of the present invention, the received data comprises at least one of the audio, image and video recorded by the remote device along with location information of the remote device.

Further, in an embodiment of the present invention, the emergency support server 102 is further configured to analyse the received data to determine the location of the remote device for identifying at least one service personnel in the proximity of the remote device. Thereafter, the received data is transmitted to the identified at least one service personnel or specialist. In another embodiment of the present invention, the emergency support server 102 is further configured to remotely activate camera devices (such as the recording devices 108) in the proximity of the remote device to capture additional information corresponding to the emergency, wherein the captured additional information automatically gets transmitted to either the service personnel or the emergency support server 102. In an embodiment, the camera devices may be configured to capture at least one of images, audio, and video and forward the captured details along with their own geographical location to either the service personnel or the emergency support server 102.

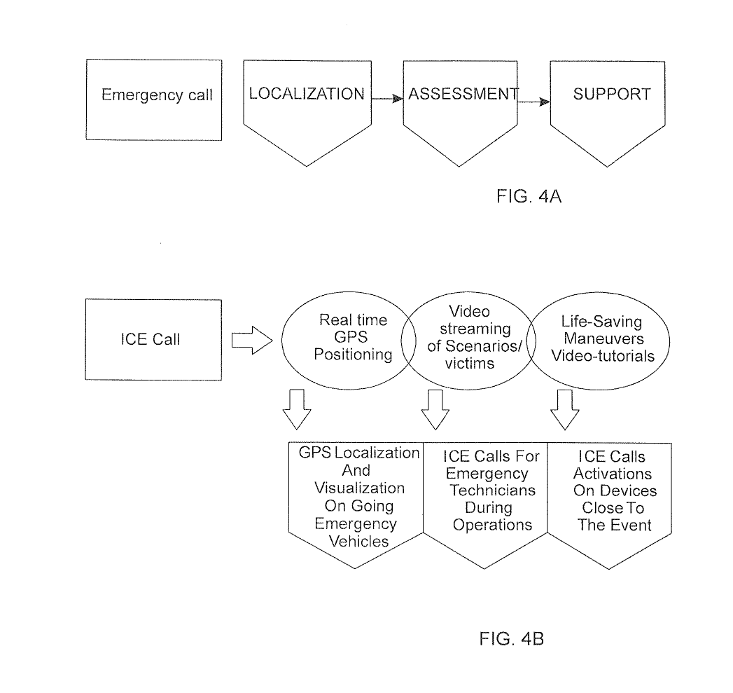

FIGS. 4-10 illustrate various block diagrams highlighting features of the present invention in various embodiments as disclosed earlier in conjunction with FIGS. 1-3 of the present invention. With reference to FIG. 4A and 4B, FIG. 4A represents a standard procedure of administering an emergency call by a conventional emergency support-service provider. As shown, the conventional emergency support-service providers first perform a localization step wherein precise location of the emergency area is determined by one or more service personnel over a telephone call. In this step, the conventional emergency support-service providers are dependent on the information provided by the caller only and do not have any means to determine reliability of the call.

Further, the conventional emergency support-service provider performs second step of assessment where the received information is accessed to determine severity of the emergency notified by the caller. Also, based on the information received, the conventional emergency support-service providers determine what resources should be dispatched along with the service personnel to provide best possible assistance in the emergency situation in the third step of support provision. Again, in this step, the conventional emergency support-service providers are dependent on the information received and do not have any other means to confirm the severity or reliability of the situation.

However, as shown in the FIG. 4B of the present invention, the aforementioned problem is well addressed by installing proposed ICE call application (as defined earlier in conjunction with FIG. 1-3 of the present invention) in all user devices. The ICE call application is configured to automatically determine a call made to an emergency support-service provider and to automatically provide in real time, geographical location of the device determined by global positioning system to the emergency support-service providers. The emergency support-service providers can easily trust the information received from the ICE call application as it is more precise and reliable method for the localization step (as disclosed in conjunction with FIG. 4A of the present invention).

Further, the ICE call application helps the emergency support-service providers in the step of assessment by providing images, video, video streaming, audio, and like of the emergency situation to the emergency support-service providers. Such information is more edifying for the step of assessment as it provides much greater details and also helps in a better way to determine the severity and reliability of the emergency situation. Moreover, the ICE call application is supportive for the emergency support-service providers in the step of providing support assistance, as the ICE call application installed at the devices of the emergency support-service providers automatically sends relevant tutorials (Life-Saving Maneuvers) to the emergency notifying device for providing best possible assistance in absence of any specialist. Additionally, the ICE call application installed at devices of the emergency support-service providers is capable of automatically notifying suitable service personnel to reach the emergency location for providing assistance. Overall, the ICE call application helps both the caller and the emergency support-service providers by the early dispatch of available resources with more precise and reliable information.

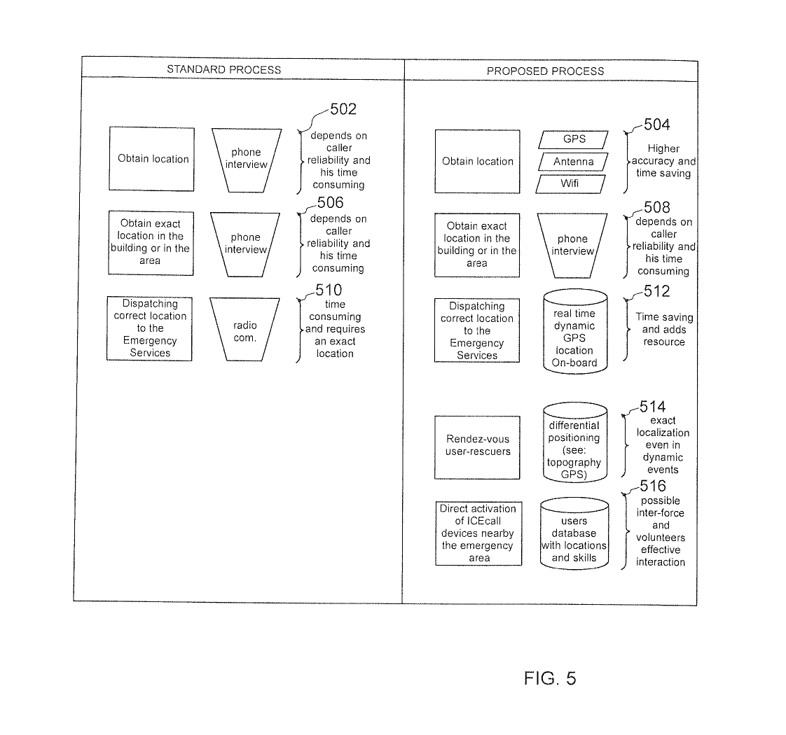

With reference to FIG. 5 of the present invention, steps 502 and 506 define problems faced by emergency support-service providers in standard procedure of obtaining precise location of an emergency area form a caller over a telephonic interview. Step 504 defines advantages of using proposed process (as proposed in FIGS. 1, 2, and 3 of the present invention) in obtaining location of an emergency by using state of the art technology. As apparent from the FIG. 5, the proposed process results in getting higher accuracy along with time savings. However, as shown in step 508, for highest accuracy in locating location of caller, e.g., flat number, floor number, or terrace, etc. the emergency support-service providers still may be dependent on the phone interview with the caller.

Similarly, in step 510 problems in the standard processes are defined where it is time consuming for the service personnel to reach to location of the emergency area as they are not aware of exact location of the caller. However, in step 512, the service personnel may use the GPS location of the caller to reach the emergency area location much early and with minimum or no chances or failing. Step 514, defines advantages of the proposed process in case where caller location is changing dynamically or the caller in travelling in a vehicle (by using state of art technologies such as differential GPS positioning). Further, step 516 defines advantages of the proposed process in retrieving additional details corresponding to the emergency situation by activating other ICE call devices in proximity with the caller to capture images, audio, video, etc of the emergency, which is not possible in case of the standard process. In an embodiment, the ICE call devices in the proximity are selected on the basis of pre-registered skills of their users.

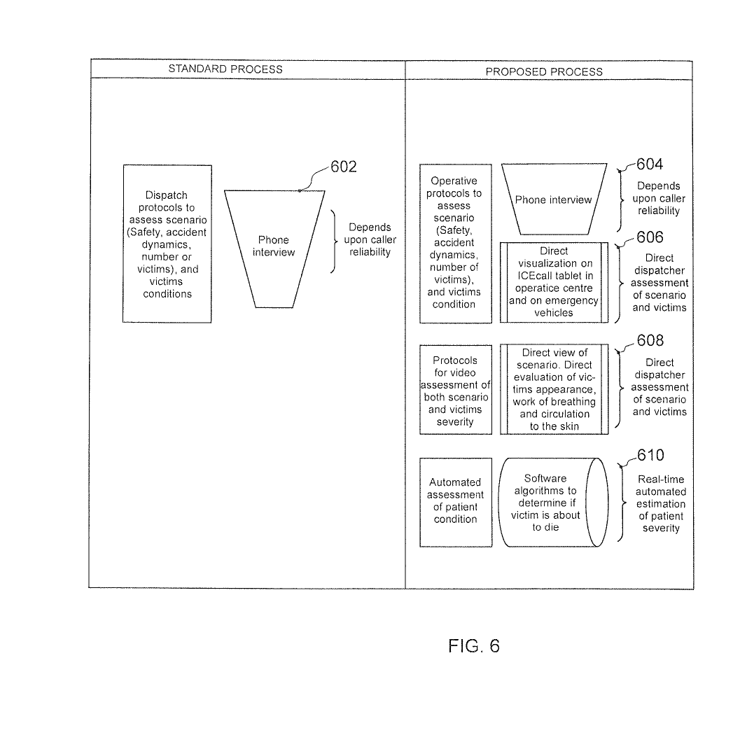

With reference to FIG. 6 of the present invention, step 602 defines problems faced by emergency support-service providers in standard procedure of determining severity of emergency situations for calculating resources that are required to be dispatched with one or more service personnel for providing best assistance in the emergency situation, as the severity of the situation can only be determined over telephonic call which is not a reliable method. Further, steps 604, 606 and 608 define advantages of using proposed process (as proposed in FIGS. 1, 2, and 3 of the present invention) over the standard process in determining severity of emergency situations by directly viewing the emergency situation via video conferencing options and more in addition to the standard process of telephonic interview.

Further, in step 610, an advantage of the ICE call app is defined where the ICE call app is equipped with software algorithms that are capable of determining medical condition of its user. In an embodiment, the ICE call app may use image processing methods for determining the medical condition of its user. In another embodiment, the ICE call app may determine vital signs of the user via various sensors available in the caller device or by pairing with additional medical devices that are used by the caller for determining his/her medical vital signs (e.g., breathing, consciousness, heart rate, blood pressure, etc). In another embodiment, the ICE call app may be used to check continuously general appearance, work of breathing, circulation to the skin and vital signs of a specific individual such as infants for sudden infant death syndrome, elders for heart diseases, and like. Further in another embodiment, the ICE call app may be used to check continuously general appearance, work of breathing, circulation to the skin and vital signs in a specific environment such as hospital ward, quarantine area, remote area and like.

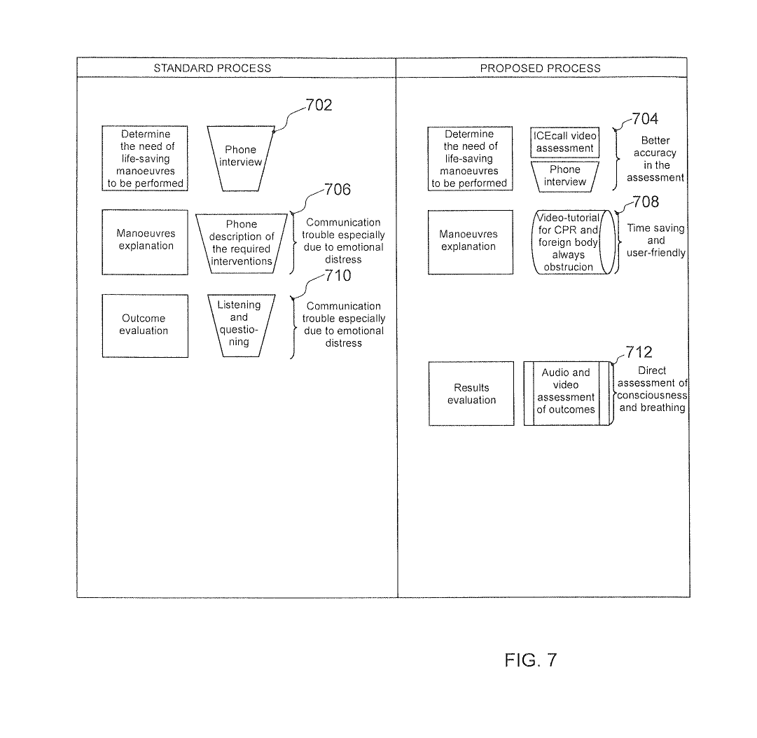

With reference to FIG. 7 of the present invention, step 702 defines problems faced by emergency support-service providers in standard procedure of determining if any life saving step is required to be performed by the caller considering severity of the emergency situations. As during emergencies, callers are panic-struck, therefore, it is difficult for emergency service providers to determine exact severity of the situation. Further, in step 706, it further hard to explain the life saving steps to the caller over telephone calls as the callers are not always in their full consciousness or in mental ability of understanding instructions. Therefore, as explained in step 710, the standard procedures face communication trouble due to the emotional distress of the caller.

Further, steps 704 defines advantages of using proposed process (as proposed in FIGS. 1, 2, and 3 of the present invention) in determining required life saving steps for the caller by determining severity of emergency situations from video streaming of the caller's situation in addition to the standard process of telephonic interview. As shown in step 708, a video tutorial may be sent to the caller to perform steps of Cardiopulmonary resuscitation (CPR), which is a more user friendly method of providing instructions to persons in emotional distress. Further, as shown in step 712, the emergency support-service providers can directly view outcomes on the health of the caller via the video conferencing. Moreover, the ICE call app may also monitor the vital statistics of the caller for assisting the emergency support-service providers.

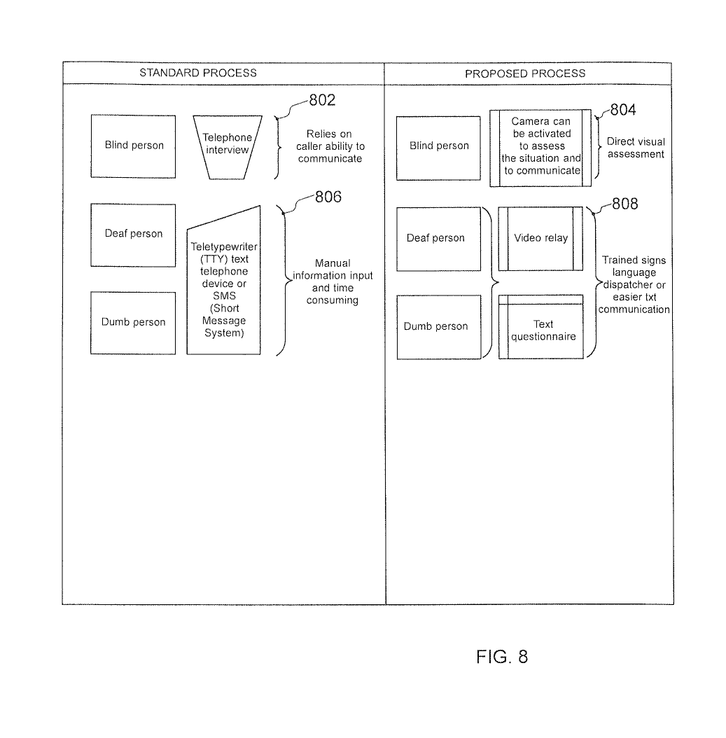

With reference to FIG. 8 of the present invention, steps 802 and 806 defines problems faced by emergency support-service providers in standard procedure of assisting a blind, deaf, or dumb person in emergency situations over telephone calls. The maximum limit available in the standard process is to send text messages or teletypewriter (TTY) text to the callers for instructing them according to the emergency situation as explained in steps 802 and 806. However, a blind person may not be able to read the text messages, a deaf person may not be able to hear the instructions over the call, and the dumb person may not be able to understand the instructions.

Nevertheless, steps 804 and 808 define advantages of using proposed process (as proposed in FIGS. 1, 2, and 3 of the present invention) in providing proper assistance to blind, deaf, and dumb callers. As shown in step 804, camera of the blind caller may be activated to check details on the emergency situation and then audio instructions may be provided to the blind caller according to the emergency situation. Further, in step 808, deaf and dumb callers may be assisted by providing video and text instructions which may also include sign languages for explaining the instructions.

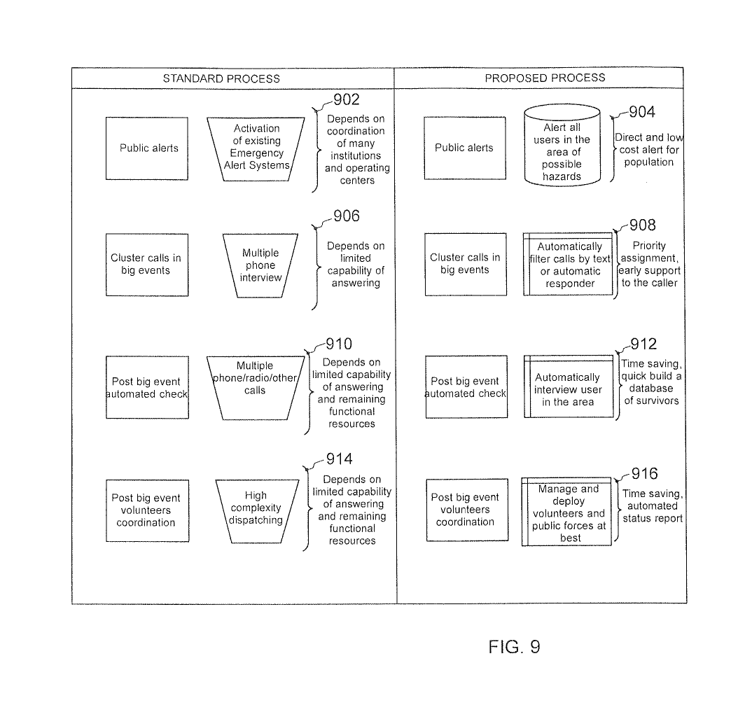

With reference to FIG. 9 of the present invention, step 902 defines problems faced by emergency support-service providers in standard procedure of activating emergency alert systems which requires coordination of many institutes.

However, the step 904 defines advantages of using proposed process (as proposed in FIGS. 1, 2, and 3 of the present invention) in providing proper and reliable audio/video proofs in fraction of time to assistance to all institutes and operation centers which helps them in taking necessary actions in early stages. Further, all pre-registered users can be alerted in fraction of time with sufficient audio/video material. In fact, in many situations is preferable to alert all the people in an area of possible hazards rather than alert only one person.

Further, the step 906, 910, and 914 defines problems faced by emergency support-service providers in standard procedure of attending multiple phone calls corresponding to same or different emergency situations (or corresponding to some big event) as number of incoming calls may be greater than number of human resources available to respond. Thereby, a solution is proposed in steps 908, 912, and 916 by using the proposed process of using automated computing device that can either provide automated assistance to every caller, may cluster incoming calls based on their content for easing human resources in call management or may prioritize incoming calls based on their content for connecting human resources only against high priority calls. Further, the automated computing device may be configured to automatically interview callers corresponding to their complaints and may also allocate voluntary rights to callers (if interested) for assisting in an emergency situation or big event (by providing them proper audio/video information on the emergency or event).

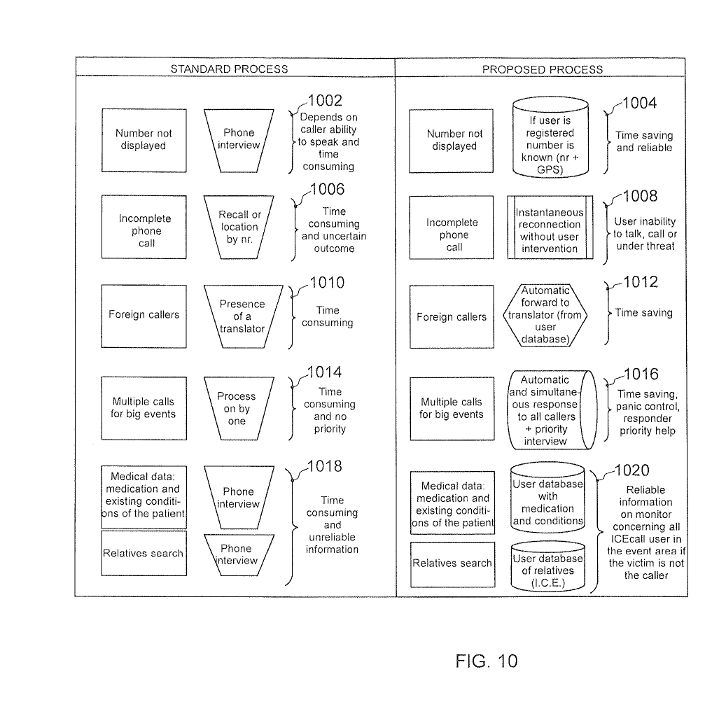

With reference to FIG. 10 of the present invention, steps 1002 and 1006 defines problems faced by emergency support-service providers in standard procedure of re-contacting a caller in cases where the call unwontedly disconnected or phone number of the caller couldn't be stored due to technical reasons. However, the steps 1004 and 1008 define advantages of using proposed process (as proposed in FIGS. 1, 2, and 3 of the present invention) in determining callers contact number and precise location via the ICE call app. Moreover, video conferencing may be used to determine the situation without needing permission from the caller (due to emergency alert initiated by the caller).

Further, the step 1010 defines problems faced by emergency support-service providers in standard procedure of attending phone calls from foreign callers which requires presence of a translator or otherwise may take time in finding and connecting the call to the translator. However, the step 1012 defines the advantages of using the proposed process where the automated computing device may automatically translate the foreign language or automatically divert the call to a pre-registered translator without any time delay.

The step 1014 defines problems faced by emergency support-service providers in standard procedure of attending multiple phone calls corresponding to national or other big events as number of incoming calls may be greater than number of human resources available to respond. Further, there may be few calls of higher priority that may remain unattended due to lack of staff at the end of emergency support-service providers. Thereby, a solution is proposed in steps 1016 by using the proposed process of using automated computing device that can either provide automated assistance to every caller or may prioritize incoming calls based on their content for connecting human resources only against high priority calls.

Further, the step 1018 defines problems faced by emergency support-service providers in standard procedure of determining medical history of callers over telephone calls as the caller may provide incomplete or wrong information due to emotional distress. However, the step 1020 defines the advantages of using the proposed process where the ICE call application may automatically transmit complete and reliable medical history and current prescriptions of the user along with user's current vital statistics to the emergency support-service providers. In an additional embodiment, the emergency support-service providers may already have a copy of the medical history of all of their pre-registered users (those who have installed ICE call app in their communication devices).

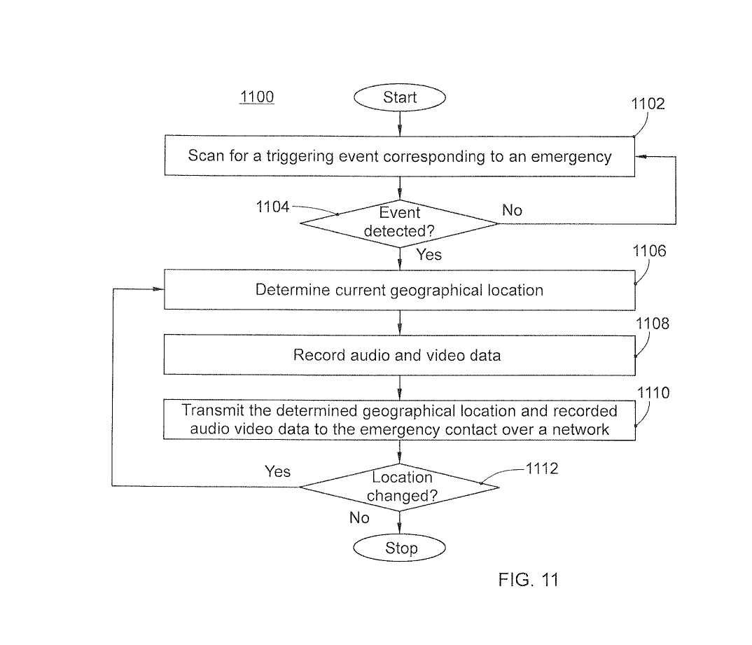

FIG. 11 illustrates a method 1100 for providing real-time emergency support to a user of a wireless communication device in response to a triggering event corresponding to an emergency, in accordance with an exemplary embodiment of the present invention. The wireless communication device (such as the user device 104 as described earlier in conjunction with FIG. 1 and FIG. 2 of the present invention) comprises at least a processor and a memory for storing at least one user information and at least one emergency contact.

In addition, the wireless communication device may further comprise (not mandatorily) a Global Positioning System (GPS) for determining precise geographical location, a camera and a microphone for recording at least one of image, video, audio, and a Wi-Fi chip for retrieving precise location of the user device and for contacting devices in proximity. Nevertheless, other short range communication interfaces may also be a part of the wireless communication device (not mandatorily) for communicating with devices available in proximity. Examples of such short range communication interfaces may include but are not restricted to Bluetooth, NFC, RFID, infrared, Zigbee, and like.

Further, the user information may include, but is not restricted to, personal information of user, business information of user, and medical history/information of the user. In an embodiment, the wireless communication device may include user information of more than one user. Further, the emergency contacts may include contact details of one or more individuals or of service providers. For example, the emergency contacts may include contact information of at least one known personnel or relative or of any general emergency service provider.

At step 1102 of the method 1100, the wireless communication device scans for a triggering event corresponding to an emergency. In an embodiment, the emergency may be any emergency including, but not restricted to, at least one of medical emergency, epidemics, criminal activity, illegal activity, fire emergency and natural disaster. Moreover, the emergency can be detected based on any triggering event such as, but not restricted to, detection of dialing a communication call to the at least one emergency contact, detection of unusual vital signs of the user, detection of rapid change in temperature or pressure, detection of a signal from the user, and like.

Further, at step 1104, the wireless communication device determines a triggering event and performs further processes as defined in step 1106. However, the wireless communication device keeps scanning for the triggering events as defined in step 1102 if no triggering event is determined at step 1104.

At step 1106, the wireless communication device determines its current geographical location via available resources in response to the detected triggering event. In an embodiment, the resources may include at least one of a cell phone network, Global positioning system, or Wi-Fi communication system for determining the current geographical location via at least one of tower triangulation method, Global Positioning System method, and Wi-Fi positioning method respectively. In an embodiment of the present invention, the wireless communication device may use all of the aforementioned resources for determining its most precise location which may also include information like building name, floor number, and room number etc.

At step 1108, the wireless communication device records at least one of image, audio, and video via available resources in response to the detected triggering event. In an embodiment of the present invention, the resources may include at least one of a camera, image sensor, and microphone for recording the image, audio and video of the emergency. Further, at step 1110, the wireless communication device may use its communication interface for transmitting the determined current geographical location along with at least one of the recorded image, recorded audio, recorded video, and the pre-stored user information to the at least one pre-stored emergency contact for apprising the emergency contact corresponding to the emergency.

In an embodiment of the present invention, the communication interface may include any of network interface controller, network interface card, network adapter, or physical network interface for enabling the wireless communication device to connect with the Internet or the network 110 (as explained earlier in conjunction with FIG. 1 of the present invention). Thereafter, at step 1112, the wireless communication device may again determine its current geographical location for determining any significant change in its location. In case if the wireless communication device determines any change in its geographical location, then the wireless communication device may repeat the steps as performed earlier from the step 1106 to notify the emergency contact corresponding to the change in its location.

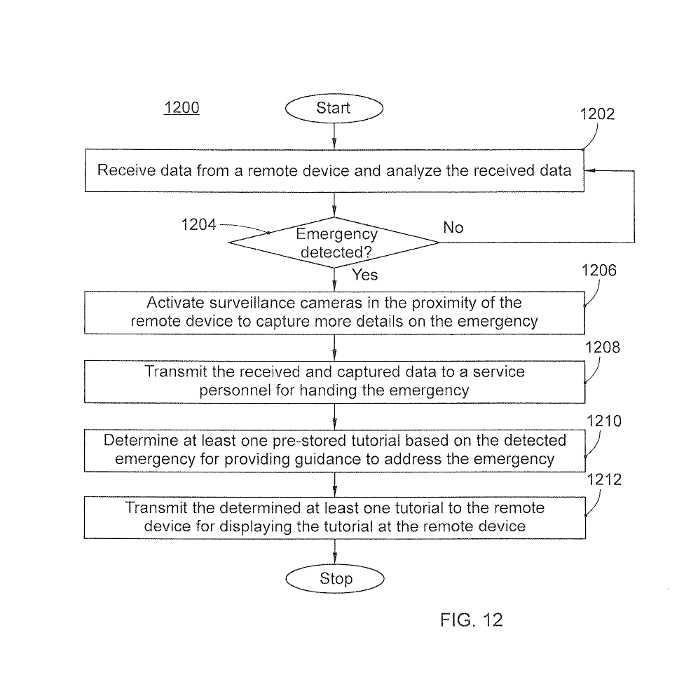

FIG. 12 illustrates a method 1200 of using an automated computing device for providing real-time emergency support to a user of a remote device during an emergency situation, in accordance with an exemplary embodiment of the present invention. In an embodiment, the emergency situation may be any emergency including, but not restricted to, at least one of medical emergency, epidemics, criminal activity, illegal activity, fire emergency and natural disaster. Further, the automated computing device (such as the emergency support server 102 as defined earlier in conjunction with FIG. 1 and FIG. 3 of the present invention) may comprise a processor operatively coupled to its memory for storing one or more tutorials corresponding to at least one type of emergency, and contact information of at least one service personnel or specialist. The automated computing device may further comprise a transceiver for transmitting and receiving data from the remote device via a network (such as the network 110 as explained earlier in conjunction with FIG. 1 of the present invention).

At step 1202 of the method 1200, the automated computing device receives certain data/information from the remote device. The received data may include current geographical location of the remote device, user information of user of the remote device, and at least one of image, audio, and video captured by the remote device. In an embodiment of the present invention, the automated computing device may also receive a request to initiate/accept an audio/video conference. Further, the user information received from the remote device may include, but not restricted to, personal information of user, business information of user, and medical history/information of the user. In an embodiment, the user information may include information corresponding to more than one user.

At step 1204, the automated computing device analyses the information received from the remote device to determine whether the received information corresponds to an emergency situation. In case if the automated computing device determines that the received information does corresponds to an emergency situation then the automated system may perform the further steps as defined in step 1206. However, if the automated computing device determines that the received information does not corresponds to an emergency situation then the automated computing device may forward the received data to some authorized personnel for taking actions and may continue determining incoming data (if any) as defined in the step 1202.

At step 1206, based on the determined geographical location of the remote device, the automated computing device determines at least one camera device (such as the recording devices 108 as explained earlier in conjunction with FIG. 1 of the present invention) in proximity to the location of the remote device (if available). Thereafter, the automated computing device requests the determined camera devices (via the network 110) to record at least one of the images, audio, and video of the emergency situation.

In case if the determined camera device is a personal portable device of a pre-registered user, then the automated computing system may request the pre-registered user of the portable device to move near to the location of the remote device for capturing audio/video data and/or for helping the user of the remote device. In an embodiment, the data captured by the camera devices in proximity to the remote device may be transmitted to the automated computing device for further processing.

At step 1208, the automated computing device determines at least one suitable service personnel or a specialist based on the type of emergency detected from the data received by the remote devices and the devices proximate to the remote device. In an embodiment of the present invention, the automated computing device also considers location of the remote device for selecting at least one suitable service personnel. Further, the selected service personnel are provided with some or all of the data received corresponding to the emergency by the automated computing device for dispatching them to the location of the remote device with best possible resources.

At step 1210, the automated computing device may select at least one tutorial stored in its memory in relevance to the emergency reported by the remote device. In an embodiment of the present invention, the tutorials stored in the memory may comprise information corresponding to remedy of various emergency situations (as explained earlier in conjunction with FIG. 1 and FIG. 2 of the present invention). The tutorials may be stored in form of text, image, graphic, audio, video, and like. In an embodiment, the tutorials may also include recorded audio/video conferences of certain prior incidences, where a specialist managed an emergency situation via the audio/video conferences.

In another embodiment, the tutorials may include information specially drafted for handling particular types of emergency situations. For example, different tutorials may be stored corresponding to cardiac arrest situation, bone fracture situation, skin burn situation, and like. Thereafter, at step 1212 the selected tutorials may be transmitted to the remote device for displaying the tutorial to the user (or helper) of the remote device. Further, in an embodiment of the present invention, the automated computing device may also be configured to search the tutorials over the Internet for providing the same to the remote device for providing guidance to address the emergency. Further, the automated computing device may only send URLs of the searched (or pre-stored) tutorials for preventing bandwidth and for providing quick response to the remote device.

It is clear that in case of a problem on the telephone line (for example a user device 104 is in line and then it has been cut off), the ICE call application is configured like a “back-up system” to automatically keep in touch the user device 104 with the specialist device 106 through another way that may be

Internet or at least another wireless communication support. It is also understood that the ICE call application works in parallel with the known and existing emergency support systems to improve them so that in case of ICE call application malfunction the emergency could be managed in the traditional manner.

Although the present invention has been described in terms of certain preferred embodiments, various features of separate embodiments can be combined to form additional embodiments not expressly described. Moreover, other embodiments apparent to those of ordinary skill in the art after reading this disclosure are also within the scope of this invention. Furthermore, not all of the features, aspects and advantages are necessarily required to practice the present invention. Thus, while the above detailed description has shown, described, and pointed out novel features of the invention as applied to various embodiments, it will be understood that various omissions, substitutions, and changes in the form and details of the apparatus or process illustrated may be made by those of ordinary skill in the technology without departing from the spirit of the invention. The inventions may be embodied in other specific forms not explicitly described s herein. The embodiments described above are to be considered in all respects as illustrative only and not restrictive in any manner. Thus, scope of the invention is indicated by the following claims rather than by the foregoing description.

The present invention is set forth and characterized in the independent claims, while the dependent claims describe other characteristics of the invention or variants to the main inventive idea.

1-12. (canceled)

13. A method for providing real-time emergency support to a user of a wireless first communication device in response to a triggering event, wherein the wireless first communication device comprises a memory having stored therein user information and at least one emergency contact, the method comprising:
determining by the wireless first communication device a current geographical location of the wireless first communication device in response to the triggering event;
recording by the wireless first communication device at least one of image, audio and video in response to the triggering event;
transmitting by the wireless first communication device, in response to the triggering event, the current geographical location and at least one of recorded image, recorded audio, recorded video and the user information to a second communication device associated to the at least one emergency contact;
receiving and analyzing, by the second communication device, the information transmitted by the first communication device;
activating, by the second communication device, at least one camera device in the proximity of the first communication device to capture additional information corresponding to the emergency; and
providing, by the second communication device, the received information and the captured additional information of the first communication device to at least one service personnel.

14. (canceled)

15. The method of claim 13, wherein the user information comprises at least one of personal information and medical history of the user.

16. The method of claim 13, wherein the emergency contact comprises contact information of at least one of an emergency service provider and an individual.

17. The method of claim 13, wherein the current geographical location is determined via at least one of Global Positioning System, Wi-Fi positioning system and tower triangulation system.

18. The method of claim 13, wherein the wireless communication device is installed in a vehicle.

19. (canceled)

20. The method of claim 13, wherein the triggering event is an event of dialing a communication call to the at least one emergency contact.

21. The method of claim 13, wherein the method further comprises receiving instructions from the emergency contact via the Internet.

22. (canceled)

23. A system for providing real-time support to a user in case of an emergency in response to a triggering event, the system comprising:
a first communication device used by the user, the first communication device comprising a first non-transitory memory operatively associated with at least one first processor, wherein the first non-transitory memory comprises user information and at least one emergency contact, the first communication device is configured to:
determine current geographic location in response to the triggering event;
record at least one of image, video, and audio in response to the triggering event; and
transmit the current geographic location and at least one of recorded image, recorded video, recorded audio and the user information to the at least one emergency contact in response to the triggering event;
a second communication device comprising a second non-transitory memory operatively associated with at least one second processor, wherein the second communication device comprises at least one contact information of at least one service personnel,
the second communication device is configured to:
receive and analyse the information transmitted by the first communication device;
activate at least one camera device in the proximity of the first communication device to capture additional information corresponding to the emergency; and
provide received information and captured additional information of the first communication device to at least one service personnel.

24. The system of claim 23, wherein the second communication device comprises at least one tutorial and is configured to transmit tutorial-data, said tutorial corresponding to the emergency.

25. The system of claim 23, wherein the received information is analysed to determine at least one of the current geographical location and medical condition of the user.

26. The system of claim 23, wherein the first communication device and the second communication device are in real-time communication with each other via Internet.

27. The system of claim 23, wherein the emergency contact comprises contact information of at least one of known personnel of user and of an emergency service provider.

28. The system of claim 23, wherein the triggering event is an event of dialing a communication call to the at least one emergency contact.

29. The system of claim 23, wherein the received information and the captured additional information of the first communication device is displayed to the at least one service personnel on the second communication device.

30. The system of claim 23, wherein the second communication device is a device installed at an emergency service provider's location.

31. The system of claim 23, wherein the second communication device is a device installed in an emergency service providing vehicle.

32. (canceled)

33. The system of claim 23, wherein the at least one service personnel is determined based on the geographical location of the first communication device.

34-48. (canceled)

49. A computer program product comprising a non-transitory computer readable storage medium having user information, at least one emergency contact, and computer usable program code for providing real-time emergency support to a user in response to a triggering event, said computer program product comprising:
computer program code configured to determine a current geographical location of a wireless communication device in response to the triggering event;
computer program code configured to record at least one of image, audio and video in response to the triggering event; and
computer program code configured to transmit the current geographical location and at least one of recorded image, recorded audio, recorded video and the user information to the at least one emergency contact in response to the triggering event,
wherein the transmitted information is to apprise the emergency contact corresponding to an emergency.

50. The computer program product of the claim 49 further comprises computer program code for transmitting a request to other devices in proximity for capturing data comprising at least one of image, audio and video corresponding to the emergency.
